(19) United States
(12) Patent Application Publication
(10) Pub. No.: US 2026/0132082 A1
(43) Pub. Date: May 14, 2026

(54) DURABLE REFLECTIVE AQUEOUS COMPOSITION

(71) Applicant: DOW GLOBAL TECHNOLOGIES LLC, Midland, MI (US)

(72) Inventors: AMIT KUMAR VERMA, Uttar Pradesh (IN); Jouko Vyorykka, Walsrode (DE); Anette Wagner, Walsrode (DE)

(21) Appl. No.: 19/119,849

(22) PCT Filed: Oct. 31, 2023
(86) PCT No.: PCT/US2023/078260

§ 371 Date: Apr. 10, 2025

(30) Foreign Application Priority Data
Nov. 2, 2022 (IN) 202241062570

(51) Int. Cl. C04B 28/04; C04B 7/02; C04B 16/02; C04B 24/28; C04B 103/00; C04B 103/40; C04B 103/44; C04B 111/00; C04B 111/80

(52) U.S. Cl. CPC C04B 28/04; C04B 7/02; C04B 16/02; C04B 24/283; C04B 2103/0057; C04B 2103/0065; C04B 2103/408; C04B 2103/44; C04B 2111/00482; C04B 2111/00586; C04B 2111/802; C04B 2201/10

(57) ABSTRACT

A durable and inexpensive coating that has high solar reflectance and low dirt pickup can be made using a mixture containing: (a) From 20 to 40 weight percent of white cement; (b) From 5 to 30 weight percent of a vinyl ester copolymer which has a glass-transition temperature of −20° C. to 35° C.; (c) at least 0.1 weight percent of a cellulosic thickener, and (d) at least 30 weight percent white fillers in which 95 to 100 weight percent of particles have a particle size of no more than 75 microns, wherein the dry mix composition contains no more than 0.1 weight percent silica and no more than 5 weight percent pozzolans and wherein all weight percentages are based on the weight of the dry components (a)-(d). The dry components can be blended together to form a dry mix, and the dry mix can be mixed with water to form an aqueous coating composition that can be applied by brushing or rolling. The coating is especially useful as a roof coating.

### FIELD

This invention relates to the field of architectural exterior coatings.

### INTRODUCTION

Architectural exterior coatings are coatings such as elastomeric roof coatings that are applied to the outside of buildings. Cement-based exterior coatings are known. See, for example, U.S. Pat. Nos. 4,614,755 and 9,249,060; US Publication 2013/0137793A1; PCT Publications 2001/002495A1 and 2011/130910A1; and Australian Publication 2001/16338A1. Cement-based coatings have the advantage that they can be supplied as a powder, which the customer blends with water before use. Supplying the powder simplifies the transport of the coating and reduces the weight that must be transported, because the water solvent does not need to be transported.

Exterior coatings desirably meet many different requirements. For example, ASTM D-6083 sets standards that acrylic-based roofing coatings should meet for viscosity, weight, volume of solids, elongation and tensile strength, adhesion, tear resistance, water resistance and fungal resistance. In addition, exterior coatings (and especially roof coatings) can desirably contribute to keeping buildings cool by having a high solar reflectance index and a high dirt pick-up resistance (because dirt-pick up darkens the coating and reduces solar reflectance over time). Finally, the coating is desirably inexpensive to produce.

A cementitious coating is needed that minimizes the use of expensive ingredients and provides useful levels of performance in one or more properties, such as viscosity, solids content, tensile strength, water resistance, solar reflectance and/or dirt pickup resistance.

### SUMMARY

One aspect of the present invention is a dry mix composition comprising:
a) from 20 to 40 weight percent of white cement;
b) from 5 to 30 weight percent of a vinyl ester copolymer which has a glass-transition temperature of −20° C. to 35° C.;
c) at least 0.1 weight percent of a cellulosic thickener; and
d) at least 30 weight percent white filler in which 95 to 100 parts-per-hundred, by weight, of the particles of white filler have a particle size of no more than 75 microns,
wherein the dry mix composition contains no more than 0.1 weight percent silica and no more than 5 weight percent pozzolans, and wherein all weight percentages are based on the weight of the dry components (a)-(d).

A second aspect of the present invention is an aqueous composition comprising the dry ingredients as described in the first aspect of the present invention and further comprising:
(e) water in a quantity such that the aqueous composition forms a slurry that has a viscosity of 85 KU to 130 KU.

A third aspect of the present invention is a process to coat an exterior surface of a structure comprising the steps of (1) applying an aqueous composition to the exterior surface of the structure; and (2) allowing the aqueous composition to set and adhere to the exterior surface of the structure, wherein the aqueous composition is an aqueous composition as described in the second aspect of the present invention.

A fourth aspect of the present invention is a structure comprising at least one exterior surface that has a coating adhered to the exterior surface, wherein the coating contains:
a) from 20 to 40 weight percent of white cement;
b) from 5 to 30 weight percent of a vinyl ester copolymer which has a glass-transition temperature of −20° C. to 35° C.;
c) at least 0.1 weight percent of a cellulosic thickener; and
d) at least 30 weight percent white filler in which 95 to 100 parts-per-hundred, by weight, of the particles of white filler have a particle size of no more than 75 microns,
wherein the coating contains no more than 0.1 weight percent silica and no more than 5 weight percent pozzolanic fillers and wherein all weight percentages are based on the weight of the dry components (a)-(d).

In certain embodiments, the dry mixes and aqueous compositions of the present invention provide an inexpensive and durable coating that has high solar reflectance and/or high dirt pickup resistance.

### DETAILED DESCRIPTION

Aspects of this invention include a dry mix powder and an aqueous composition. In some embodiments, the aqueous composition is made by first making the dry mix and then blending water into the dry mix. In some embodiments, the aqueous composition is made by first blending one or more components of the aqueous composition with water, and later blending the remaining components of the aqueous composition to the water-borne mixture, separately or together. Both embodiments can make the same aqueous composition, but the first embodiment makes and uses the dry mix of the present invention, and the second embodiment does not. In both the aqueous composition and dry mix, the selection and relative proportions of the components, other than water, are the same.

The dry mix/aqueous composition contains white cement. White cement provides greater solar reflectance than other cements that may be chosen, without needing additional pigments. White cement is a variation of ordinary Portland cement, in which components that add color are minimized. For example, in some embodiments, the limestone used to make white cement contains high levels of calcium and low levels of chromium, manganese, copper and iron. In some embodiments, the white cement contains less than 0.005 weight percent Cr₂O₃ and/or less than 0.05 weight percent Mn₂O₃ and/or less than 0.5 weight percent Fe₂O₃. In some embodiments, conventional clays are replaced in white cement with kaolin, which has less color. In some embodiments, the white cement contains little or no coal dust or fly ash.

In some embodiments, the white cement has a solar reflectance (when new) of at least 70 percent or at least 75 percent or at least 80 percent or at least 82 percent or at least 85 percent or at least 86 percent. There is no maximum desired reflectance, but solar reflectance index above 95 percent may be unnecessary. In some embodiments, the white cement has a solar reflectance index of at least 90 or at least 95 or at least 100 or at least 110. There is no maximum desired reflectance, but solar reflectance index above 125 may be unnecessary.

Suitable white cements are commercially available, and their use is well-known in the construction industry. Manufacture of white cement is described in numerous references, such as Moreova et al., “White Cement—Properties, Manufacture, Prospects” 45 (4) Ceramics—Silikáty at 158-163 (2001) and “White Cement—Manufacture, Properties and Uses” at https://theconstructor.org/concrete/white-cement/23732/.

The dry mix/aqueous composition contains from 20 to 40 weight percent white cement, based on the dry components and excluding water. In some embodiments, the dry mix/aqueous composition contains at least 25 weight percent white cement or at least 30 weight percent or at least 32 weight percent or at least 34 weight percent, based on the dry components and excluding water. In some embodiments, the dry mix/aqueous composition contains at most 38 weight percent white cement or at most 36 weight percent, based on the dry components and excluding water.

The dry mix/aqueous composition contains a vinyl ester copolymer which has a glass-transition temperature of −20° C. to 35° C. In the aqueous composition, the vinyl ester copolymer is suspended as an emulsion, and in the dry mix, the vinyl ester copolymer is in the form of a redispersible powder that can form an emulsion when blended with water. In many embodiments, vinyl ester copolymers require an emulsifier in order to form a stable emulsion in water. In such embodiment, the emulsifier is also present in the redispersible powder and in the aqueous composition.

In some embodiments, the vinyl ester copolymer and emulsifier are selected such that the emulsion is stable in a cementitious environment. Cement creates an alkaline environment that is high in calcium ions. This environment can cause some emulsions to break down. Other combinations of vinyl ester copolymer and surfactant are known to form stable emulsions in this environment, and the combinations that form stable emulsions may be advantageously used in dry mixes/aqueous compositions of the present invention.

Vinyl ester copolymers contain repeating units derived from one or more vinyl ester monomers, such as vinyl acetate, vinyl propionate, vinyl butyrate, vinyl 2-ethylhexanoate, vinyl laurate, 1-methylvinyl acetate, vinyl pivalate, and vinyl esters of C-branched monocarboxylic acids having 9 to 11 carbon atoms, such as vinyl versatate. In some embodiments, the vinyl ester copolymer comprises vinyl acetate. In some embodiments, the vinyl ester copolymer comprises both vinyl acetate and vinyl esters of C-branched monocarboxylic acids having 9 to 11 carbon atoms; examples of such polymers are commercially available under the trademark VeoVa.

In some embodiments, the vinyl ester copolymer further comprises repeating units derived from ethylene. For example, vinyl ester-ethylene copolymers may contain at least 1 weight percent repeating units derived from ethylene or at least 5 weight percent or at least 10 weight percent, and vinyl ester-ethylene copolymers may contain at most 60 weight percent repeating units derived from ethylene or at most 50 weight percent.

In some embodiments, the vinyl ester copolymer further comprises repeating units derived from an acrylic or methacrylic ester such as n-butyl acrylate or 2-ethyl hexyl acrylate. For example, vinyl ester-acrylic ester copolymers may contain 30 to 90 weight percent repeating units derived from vinyl ester, 1 to 60 weight percent repeating units derived from acrylic ester and 1 to 40 weight percent repeating units derived from ethylene. In some embodiments, the vinyl ester copolymer comprises no measurable quantity of acrylic or methacrylic ester.

Examples of suitable vinyl ester copolymers are described in U.S. Pat. No. 6,890,975. In some embodiments, the vinyl ester copolymer is a vinyl acetate-ethylene (VAE) copolymer. In some embodiments, the vinyl ester copolymer is a vinyl ester of versatic acid (VEOVA) copolymer.

In some embodiments, the vinyl ester copolymer has a weight average molecular weight (Mw) of at least 300,000 Da or at least 350,000 Da or at least 400,000 Da. In some embodiments, the vinyl ester copolymer has a weight average molecular weight (Mw) of at most 2,000,000 Da or at most 1,500,000 Da or at most 1,200,000 Da.

In some embodiments, the vinyl ester copolymer has a glass-transition temperature of at least −15° C. or at least −12° C. or at least −10° C. or at least −5° C. or at least 0° C. In some embodiments, the vinyl ester copolymer has a glass-transition temperature of at most 30° C. or at most 28° C. or at most 25° C. or at most 22° C. or at most 20° C. or at most 15° C. or at most 10° C. or at most 5° C.

As previously discussed, the vinyl ester copolymer may be paired with an emulsifier. Examples of suitable emulsifiers include surfactants. In some embodiments, the surfactant is a nonionic surfactant. Examples of nonionic surfactants include nonylphenol ethoxylates and fatty (C₆ to C₃₀) alcohol ethoxylates, such as TERGITOL™ 15-S-40 and TERGTOL™ NP10, which are commercially available from The Dow Chemical Company.

In some embodiments the emulsifier is poly-vinyl alcohol (PVOH). PVOH is a polyvinyl acetate in which acetate groups have been hydrolyzed to alcohol groups. In some embodiments, the PVOH is at least 70% hydrolyzed or at least 80% hydrolyzed or at least 85% hydrolyzed or at least 87% hydrolyzed. In some embodiments, the PVOH is at most 95% hydrolyzed or at most 90% hydrolyzed or at most 88% hydrolyzed. Examples of suitable PVOH have a weight average molecular weight (Mw) of at least 15,000 Da or at least 20,000 Da. Examples of suitable PVOH have a weight average molecular weight (Mw) of at most 150,000 Da or at most 120,000 Da. Examples of suitable PVOH include PVOH 04-88 and PVOH 26-88, which are commercially available from Sigma-Aldrich.

In some embodiments, the weight ratio of vinyl ester copolymer to emulsifier is at most 98:2 or at most 96:4 or at most 95:5. In some embodiments, the weight ratio of vinyl ester copolymer to emulsifier is at least 75:5 or at least 80:20 or at least 85:15.

In some embodiments, the vinyl ester copolymer and surfactant are selected such that the resulting emulsion has a particle size of at least 200 nm or at least 400 nm or at least 500 nm or at least 600 nm. In some embodiments, the vinyl ester copolymer and surfactant are selected such that the resulting emulsion has a particle size of at most 1000 nm or most 800 nm.

In some embodiments, redispersible powders may sometimes further contain additives such as anti-caking agents. Calcium carbonate and kaolin are examples of common anticaking agents. Nevertheless, redispersible powders may contain a small amount of moisture. In some embodiments, the redispersible powder contains no more than 5 weight percent moisture or no more than 4 weight percent or no more than 3 weight percent or no more than 2 weight percent or no more than 1 weight percent, based on the weight of the redispersible powder. In some embodiments, the redispersible powder may contain no detectable moisture content (0 weight percent, based on the weight of the redispersible powder).

Examples of suitable redispersible powders are commercially available, such as under the DOW™ Latex Powder trademarks, such as DOW™ Latex Powder 2300, DOW™ Latex Powder 2000 or DOW™ Latex Powder 212, and under the VaVeova and VaE-Veova trademarks. Other redispersible powders can be made in aqueous dispersion by emulsion copolymerization of vinyl ester monomers and ethylene monomer according to known processes, such as are described in Lindemann, Vinyl Acetate/Ethylene Emulsion Copolymers, Paint Manufacture, September 1968, at 30-36, and U.S. Pat. No. 5,576,384 and US Application 2009/0069495 A1. For example, the redispersible powder can be made by (1) forming a vinyl ester copolymer emulsion containing the vinyl ester copolymer and the emulsifier and (2) drying the emulsion to form the powder such as by spray drying. In such case, the redispersible powder may contain both the vinyl ester copolymer and the surfactant that were present in the emulsion.

The dry mix/aqueous composition contains from 5 to 30 weight percent vinyl ester copolymer, based on the dry components and excluding water. In some embodiments, the quantity of vinyl ester copolymer in the dry mix/aqueous composition is at least 7 weight percent or at least 10 weight percent or at least 13 weight percent or at least 14 weight percent, based on the weight of dry components and excluding water. In some embodiments, the quantity of vinyl ester copolymer in the dry mix/aqueous composition is at most 25 weight percent or at most 20 weight percent or at most 18 weight percent or at most 16 weight percent, based on the weight of dry components and excluding water.

The dry mix/aqueous composition further contains a cellulosic thickener. Common cellulosic thickeners include cellulose ethers, such as methyl cellulose, ethyl cellulose and methyl ethyl cellulose. Cellulose ethers can increase the water retention of the aqueous composition and lengthen open time. Cellulose ethers can also improve the workability and viscosity of the aqueous composition. Appropriate cellulose ethers are commercially available, such as under the WALOCEL™ OR METHOCEL™ trademark.

The dry mix/aqueous composition contains at least 0.1 weight percent of cellulosic thickener, based on the dry components and excluding water. In some embodiments, the dry mix/aqueous contains at least 0.2 weight percent of cellulosic thickener or at least 0.3 weight percent or at least 0.4 weight percent, based on the dry components and excluding water. In some embodiments, the dry mix/aqueous composition contains at most 2 weight percent cellulosic thickener or at most 1 weight percent or at most 0.8 weight percent or at most 0.6 weight percent, based on the dry components and excluding water.

The dry mix/aqueous composition contains a white inorganic filler. Examples of suitable white fillers include dolomite, titanium dioxide and calcium carbonate. In some embodiments, the white inorganic filler has a reflectance (Y) of at least 80 percent or at least 82 percent or at least 85 percent or at least 87 percent. There is no maximum desired reflectance, but reflectance above 97 percent or 95 percent may be unnecessary. Suitable inorganic fillers are commercially available.

From 95 to 100 parts-per-hundred, by weight, of particles in the white inorganic filler have a particle size of at most 75 micron. In some embodiments, from 95 to 100 parts-per-hundred, by weight, of particles in the white inorganic filler have a particle size of at most 65 micron or at most 55 micron. In some embodiments, at least 50 parts-per-hundred, by weight, of particles in the white inorganic filler have a particle size of at least 35 micron or 40 micron or 45 micron. In some embodiments, the white inorganic filler has a particle size such that 95 to 100 parts-per-hundred, by weight, of particles will pass through a screen with a mesh size of at least 200 or at least 230 or at least 270 or at least 300. In some embodiments, the white inorganic filler has a particle size such that at least 50 parts-per-hundred, by weight, of particles are retained by a screen with a mesh size of at most 400 or at most 325.

The dry mix/aqueous composition contains from 30 to 75 weight percent white inorganic filler, based on the dry components and excluding water. In some embodiments, the dry mix/aqueous composition contains at least 35 weight percent of white inorganic filler or at least 40 weight percent or at least 45 weight percent or at least 50 weight percent, based on the dry components and excluding water. In some embodiments, the dry mix/aqueous composition contains at most 70 weight percent of inorganic filler or at most 68 weight percent or at most 65 weight percent or at most 60 weight percent, based on the dry components and excluding water.

The concentration of silica and pozzolans in the filler should be low enough that the overall dry mix/aqueous composition contains no more than 0.1 weight percent silica and no more than 5 weight percent pozzolans. In some embodiments, the dry mix/aqueous composition contains no more than 3 weight percent pozzolans or no more than 2 weight percent pozzolans or no more than 1 weight percent pozzolans. There is no minimum concentration of silica or pozzolans; in some embodiments the dry mix/aqueous composition contains no measurable amount (0 weight percent) of silica and/or pozzolans.

Suitable white fillers are commercially available.

In some embodiments, the dry mix/aqueous composition further contains a polymeric dispersant. Polymeric dispersants are known in coating technology. See, for example, “Dispersants Technology and Benefits” published by Lubrizol Corporation (2018), and U.S. Pat. No. 6,326,449 B1. Dispersants reduce agglomeration of solid components in the aqueous composition. In some embodiments, the polymeric dispersant is a polymer containing anionic functional groups, such as a polymer or copolymer of acrylic acid neutralized by a base.

In some embodiments, the polymeric dispersant is a homopolymer, which can be made by polymerizing acrylic, methacrylic, crotonic, or maleic acids together. In some embodiments, the polymeric dispersant is a copolymer, which can be made by polymerizing a combination of hydrophilic and/or hydrophobic comonomers. Examples of suitable hydrophilic monomers include acrylic, methacrylic, crotonic, or maleic acids. Examples of suitable hydrophobic monomers include styrene, ethyl acrylate, butyl acrylate, ethylhexyl acrylate, methyl methacrylate, butyl methacrylate, or isobutylene. The acid groups may be neutralized before use to form either ammonium or alkali metal salts. Examples of suitable polymeric dispersants are commercially available from The Dow Chemical Company under the trademarks TAMOL™, OROTAN™, ACUSOL™ and ACUMER™.

In some embodiments, the dry mix/aqueous composition contains at least 0.05 weight percent of polymeric dispersant or at least 0.1 weight percent or at least 0.15 weight percent or at least 0.2 weight percent, based on the dry components and excluding water. In some embodiments, the dry mix/aqueous composition contains at most 2 weight percent of polymeric dispersant or at most 1 weight percent or at most 0.8 weight percent or at most 0.5 weight percent, based on the dry components and excluding water.

In some embodiments, the dry mix/aqueous composition further contains a polysiloxane (silicone) polymer powder. Polysiloxane can increase the hydrophobicity of the coating formed by the aqueous composition, can improve flexibility and reduce brittleness of the coating, and/or can improve resilience of the coating to freeze/thaw cycles.

Polysiloxanes are oligomers or polymers characterized by the repeating unit:

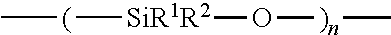

wherein each of R¹ and R² is independently an organic moiety and n is a number of repeating units. In some embodiments, each R group is a relatively non-reactive organic group such as an unsubstituted or halogenated alkyl, aryl or alkaryl group. For example,
One or both R groups may independently be alkyl or fluorinated alkyl, and in some embodiments the alkyl or fluorinated alkyl groups may contain from 1 up to 8 or up to 6 or up the 4 carbon atoms. In some embodiments, each R group is independently a methyl or trifluoromethyl group.
One or both R groups may independently be phenyl or alkyl-substituted phenyl groups such a dimethyl phenyl or trimethyl phenyl. In some embodiments, aryl groups may be avoided to improve light stability of the siloxane

In some embodiments, the polysiloxane forms a ring, such as a ring containing 3 or 4 of the repeating units illustrated above. In some embodiments, the polysiloxane forms a substantially linear chain capped at the end with an —OH or —OR³ moiety, wherein R³ is an organic moiety as previously described.

In some embodiments, the glass transition temperature (Tg) of the polysiloxane is at least −150° C. or at least −125° C. In some embodiments, the glass transition temperature (Tg) of the polysiloxane is at most −20° C. or at most −25° C.

In some embodiments, the polysiloxane is hydrophobic.

Many appropriate polysiloxanes are insoluble in water; they may be maintained in a water-based emulsion with emulsifiers. Emulsifiers maintain insoluble liquids in suspension in an aqueous solvent. Emulsifiers are generally surfactants, such as anionic and nonionic surfactants. For example, some common emulsifiers are fatty alkyl sulfates such as sodium lauryl sulfate, alcohol ether sulfates, aryl sulfonates such as branched sodium dodecyl benzene sulfonate, alkyldiphenyloxide disulfonates such as disodium lauryl phenyl ether disulfonate, nonylphenol ether sulfates such as ammonium nonylphenol ether sulfate, fatty alcohol ethoxylates, nonylphenol ethoxylates, or alkyl phosphate esters such as ammonium phosphate, polyoxyethylene tridecyl ether. Suitable emulsifiers are available under the trademarks DOWSIL™, TERGITOL™, TRITON™, RHODAFAC™, RHODACAL™, DISPONIL™, Lutensol™ and DOWFAX™.

Appropriate polysiloxanes and polysiloxane emulsions are commercially available, such as under the DOWSIL™ trademarks, such as DOWSIL™ SHP 60 Plus and DOWSIL™ SHP 50 Plus. Other polysiloxanes can be made by condensing a dichlorosilane in the presence of excess water as described in Treatise on Coatings Vol 1, Part III (Film Forming Composition). Edited by Raymond R. Myers and J. S. Long. Published by Marcel Dekker, Inc. New York 1972.

Polysiloxanes add cost to the dry mix/aqueous composition, so in some embodiments it may be desirable to omit the polysiloxane; in this case the dry mix/aqueous composition contains no measurable (0 weight percent) polysiloxane. In other embodiments, the dry mix/aqueous composition contains at least 0.1 weight percent of polysiloxane or at least 0.5 weight percent or at least 0.8 weight percent or at least 1 weight percent, based on the dry components and excluding water. In some embodiments, the dry mix/aqueous composition contains at most 5 weight percent of polysiloxane or at most 4 weight percent or at most 3 weight percent or at most 2 weight percent, based on the dry components and excluding water.

In addition to the components named above, some embodiments of the dry mix/aqueous composition may optionally contain other additives, such as accelerators, retarders, defoamers, and wetting agents.
Accelerators speed the setting of the aqueous composition. They may be especially useful in cold-weather application. Examples of common accelerants include calcium nitrate, calcium nitrite, calcium formate and certain aluminum compounds. Accelerator formulations with instructions for their use are commercially available.
Retarders slow the setting time of the aqueous composition. Examples of common retarders include calcium, sodium and ammonium salts of lignosulfonic acid, hydroxycarboxylic acids such as hydroxylic acid, carbohydrates, lead oxides, zinc oxides, phosphates, borates and fluorates. Retarder formulations with instructions for their use are commercially available.
Plasticizers (also called “water reducers”) improve workability of cement compositions with lower water content. Examples of plasticizers include sulfonated melamine-formaldehyde condensates, sulfonated naphthalene-formaldehyde condensates, modified lignosulfonates and polycarboxylates. Plasticizer formulations with instructions for their use are commercially available.
Defoamers can reduce air-entrainment and voids in the aqueous composition. Examples of defoamers include mineral oils, polyglycols and polyethersiloxanes. Defoamers with instructions for their use are commercially available.
Wetting agents reduce surface tension of the aqueous composition to provide a smoother, more even coating. Many common wetting agents are surfactants. Suitable wetting agents with instructions for their use are commercially available.

In some embodiments, the dry mix/aqueous composition contains at most 5 weight percent of the other additives or at most 3 weight percent or at most 2 weight percent or at most 1 weight percent, based on the dry components and excluding water. In some embodiments, the dry mix/aqueous composition contains no measurable content of the other additives (0 weight percent, based on the weight of dry components and excluding water).

To make the dry mix, the dry components are blended together. Suitable dry blending equipment, such as mixers and mills, are commercially available with instructions for their use.

To make the aqueous composition, the dry components are thoroughly mixed with water, either separately or together as a dry mix, as previously described, to form a slurry.

In some embodiments, the weight ratio of water to dry components in the aqueous composition is at least 20:100 or at least 25:100 or at least 30:100 or at least 35:100 or at least 40:100 or at least 45:100 or at least 50:100 or at least 55:100 or at least 58:100. In some embodiments, the weight ratio of water to dry components in the aqueous composition is at most 100:100 or 80:100 or at most 75:100 or at lost 70:100 or at most 65:100 or at most 62:100. Different selections of dry components may require different ratios of water in order to provide a slurry with optimal viscosity.

In some embodiments, the aqueous composition contains at least 17 weight percent water or at least 20 weight percent water or at least 23 weight percent or at least 26 weight percent or at least 29 weight percent or at least 31 weight percent or at least 35 weight percent or at least 35 weight percent or at least 36 weight percent. In some embodiments, the aqueous composition contains at most 50 weight percent water or at most 44 weight percent water or at most 43 weight percent or at most 42 weight percent or at most 41 weight percent. In some embodiments, the dry ingredients and quantity of water are selected to provide an aqueous composition whose viscosity low enough that it can be applied smoothly with a brush or roller. In some embodiments, the dry ingredients and quantity of water are selected to provide an aqueous composition whose viscosity high enough that it adheres smoothly to the substrate and resists thinning and dripping while it is drying.

In some embodiments, the aqueous composition has a viscosity of at least 85 Krebs Units (KU) or at least 90 KU or at least 95 KU or at least 100 KU. In some embodiments, the aqueous composition has a viscosity of at most 130 KU or at most 125 KU or at most 120 KU or at most 115 KU. Krebs Units do not convert to SI Units (centipoise) in a linear fashion. Instrument makers often publish conversion tables to convert KU measured on their equipment to centipoise. See, for example, “Brookfield KU-2 Viscometer Operating Instructions Manual No. M04-242-E1213. Table A2”, published by Brookfield Engineering Laboratories, Inc. In some embodiments, the viscosity of the aqueous composition at 25° C. is at least 950 cP or at least 1100 cP or at least 1350 cP of at least 1550 cP. In some embodiments, the viscosity of the aqueous composition at 25° C. is at most 3800 cP or at most 3300 cP or at most 2900 cP or at most 2510 cP.

One example of the aqueous composition comprises:
a) From 20 to 40 weight percent of white cement;
b) From 5 to 30 weight percent (or 10 to 20 weight percent) of a vinyl ester copolymer which has a glass-transition temperature of −20° C. to 35° C.;
c) from 0.1 to 2 weight percent of a cellulose ether;
d) at least 30 weight percent white fillers in which 95 to 100 parts-per-hundred, by weight, of the particles of white filler have a particle size no more than 55 micron; and
e) water in a quantity such that the aqueous composition is a slurry that has a viscosity of 90 KU to 120 KU,
wherein all weight percentages are based on the weight of the dry components (a)-(d), excluding the water, and wherein the aqueous composition contains no more than 0.1 weight percent silica and no more than 5 weight percent pozzolanic fillers.

Another example of aqueous composition comprises:
a) From 20 to 40 weight percent of white cement;
b) From 5 to 30 weight percent (or from 10 to 20 weight percent) of a vinyl ester copolymer which has a glass-transition temperature of −20° C. to 35° C.;
c) from 0.1 to 2 weight percent of a cellulose ether;
d) at least 30 weight percent white fillers in which 95 to 100 parts-per-hundred, by weight, of the particles of white filler have a particle size no more than 55 micron;
e) from 0.1 to 3 weight percent (or from 0.2 to 2 weight percent) polymeric dispersant;
f) up to 3 weight percent polysiloxane; and
g) water in a quantity such that the aqueous composition is a slurry that has a viscosity of 90 KU to 120 KU,
wherein all weight percentages are based on the weight of the dry components (a)-(f), excluding the water, and wherein the aqueous composition contains no more than 0.1 weight percent silica and no more than 5 weight percent pozzolanic fillers.

Working life is the amount of time after the dry components are blended with water that the aqueous composition maintains a low enough viscosity in an open container that it can be applied smoothly by conventional means, such brushing. Working life varies depending on a number of factors, such as temperature, sun exposure, humidity and air circulation, as well as the contents of the dry components and the amount of water that is added. In some embodiments, the aqueous composition has working life at 25° C. of at least 60 minutes or at least 90 minutes or at least 120 minutes or at least 180 minutes or at least 240 minutes. In some embodiments, the aqueous composition has a working life at 25° C. of at most 500 minutes or at most 360 minutes.

Among other uses, the aqueous composition can be used as an exterior coating, and particularly as a roof coating. First, the aqueous composition is applied to a substrate. Second, the aqueous composition is allowed to set. Each of these steps is well-known.

In some embodiments, the substrate is a vertical surface, such as a wall. Examples of appropriate substrates for a wall include any known building surface material, such as wood, plaster, concrete or synthetic plank. In some embodiments, the substrate is a horizontal or tilted surface, such as a roof. Examples of appropriate substrates for a roof include any known roof surface, such as shingles, ceramic tiles, metal roofing, concrete, a polymer membrane or built-up roof (tar and gravel). In some embodiments, the roof surface comprises a membrane, such as ethylene propylene diene terpolymer (EPDM), thermoplastic polyolefin (TPO) or polyvinyl chloride. In some embodiments, the substrate comprises concrete.

The aqueous composition may be applied to the substrate known means such as spraying, rolling or brushing. As with other aqueous outdoor coatings, it would commonly be applied during dry weather with a temperature high enough for the coating to substantially set in a reasonable time frame. In some embodiments, the temperature will be at least 10° C. or 12° C. or at least 15° C. or at least 20° C. or at least 23° C. In some embodiments, the coating is applied with an average thickness of at least 200 micron or at least 300 micron or at least 350 micron or at least 400 micron. In some embodiments, the coating is applied with an average thickness of at most 1000 micron, or at most 800 micron or at most 700 micron or at most 600 micron.

The aqueous composition is allowed to set, leaving behind a solid dried coating adhered to the substrate. In some embodiments, the coating may become dry to the touch and able to withstand contact and weather without smearing in a relatively short amount of time, even though the coating continues to chemically cure and set for a longer time thereafter. For this application, we say that the coating that is dry to the touch and able to withstand contact and weather without smearing is “substantially set”, whereas the coating that has chemically finished the curing and setting reactions is “fully cured”. As with other aqueous outdoor coatings, the aqueous composition may be applied as a single coat, or two or more coats may be applied with each coat permitted to substantially set before the next coat is applied. The time needed for the coating to substantially set may vary depending on the temperature and humidity at which setting occurs. In some embodiments, the coating is substantially set in at least 15 minutes or at least 20 minutes or at least 30 minutes or at least 40 minutes or at least 50 minutes or at least 60 minutes. In some embodiments, the coating is substantially set in at most 6 hours or at most 5 hours or at most 4 hours or at most 3 hours or at most 2 hours or at most 90 minutes or at most 60 minutes or at most 50 minutes or at most 40 minutes. In some embodiments, the coating may be fully cured in one week or more.

The contents of the set coating are derived from the coating components of the aqueous composition. In some embodiments, the set coating comprises no more than 5 weight percent solvent, or no more than 3 weight percent or no more than 1 weight percent or no more than 0.5 weight percent. There is no required content of solvent in the coating but in some cases, it may be impractical to remove solvent to a content below 0.01 weight percent. In some embodiments, the coating has an average thickness of at least 100 micron or at least 150 micron or at least 200 micron. In some embodiments, the coating has an average thickness of at most 600 micron, or at most 500 micron or at most 400 micron or at most 350 micron or at most 300 micron.

In some embodiments, the set coating has tensile adhesion of at least 1.00 MPa or at least 1.10 MPa or at least 1.15 MPa or at least 1.25 MPa or at least 1.35 MPa. There is no maximum desired tensile adhesion, but in some embodiments a tensile adhesion above 2.00 MPa or 1.65 MPa is unnecessary.

In some embodiments, the set coating has water absorption of at most 40 percent or at most 35 percent or at most 30 percent or at most 25 percent. There is no minimum desired water absorption, but in some embodiments a water absorption below 10 percent or 20 percent is unnecessary.

In some embodiments, the set coating has solar reflection index (SRI) of at least 90 or at least 100 or at least 105 or at least 110 or at least 115. There is no maximum desired SRI, but in some embodiments an SRI above 150 or 125 is unnecessary.

Accelerated Dirt Pickup Resistance (DPUR) for coatings can be measured by measuring the decrease in reflectance (L) of a coated panel after exposure the UV and/or dirt substitute, followed by light washing, as described in the Test Methods. A lower percentage decrease indicates higher dirt pickup resistance. In some embodiments, the reflectance of the set coating that is exposed to both UV radiation and dirt substitute decreases by no more than 20 percent or no more than 15 percent or no more than 12 percent or no more than 10 percent or no more than 8 percent or no more than 6 percent. There is no minimum desired decrease in reflectance of the set coating that is exposed to both UV radiation and dirt substitute, but in some embodiments a decrease of at least 1 percent or at least 3 percent or at least 5 percent may be acceptable.

Dirt Pickup Resistance (DPUR) for coatings can also be measured by measuring the color change (ΔE) of a coated panel before and after 10 months exposure to outdoor ambient dust and dirt, as described in the Test Methods. Again, a lower color change indicates higher dirt pickup resistance. In some embodiments, the color change (ΔE) is no more than 20 percent or no more than 15 percent or no more than 12 percent or no more than 10 percent or no more than 8 percent or no more than 7 percent. The is no minimum desired color change, but in some embodiments color change (ΔE) of at least 1 percent or at least 3 percent or at least 5 percent may be acceptable.

In some embodiments, the set coatings of this invention exhibit the following properties, as measured according to the Test Methods listed below:

### Test Methods

Unless stated otherwise, measurements listed in this application are made using the following test methods:

| Parameter | Test |
|---|---|
| Solar Reflectance of Concrete | ASTM C 1549 |
| Particle Size (Filler) | ASTM E3340-22 |
| Reflectance of Filler | ASTM E991-21 |
| Glass Transition Temperature | ASTM E1356-08(2014) |
| Molecular Weight | See description below |
| Viscosity (Krebs Units) | ASTM D-562 |
| Water Absorption (7 Day) | ASTM D-471 |
| Tensile Adhesion (14 day) | EN 1348 |
| Solar Reflection Index | ASTM E 1980 |
| Impact Resistance of Coatings | ASTM 2794 |
| Working life | See description below |
| Color Change (ΔE) | ASTM 2244 |
| Accelerated Dirt Pick-Up | See description below |

### Working-Life:

An open container of the sample is kept in indoors at room temperature. The sample is painted on a concrete slab using a fresh brush at the beginning and retested every 30 min. The working-life is considered ended when the sample will no longer brush on smoothly.

### Molecular Weight

Molecular weight/molecular weight distribution and a Mark-Houwink plot for branching structure analysis are measured using Triple Detector Gel Permeation Chromatography. The processes and equations utilized are described in U.S. Pat. No. 8,871,887. U.S. Pat. No. 8,871,887 is incorporated by reference. For the Gel Permeation Chromatography (GPC) processes (Conventional GPC, Light Scattering (LS) GPC, Viscometry GPC and gpcBR), a Triple Detector Gel Permeation Chromatography (3D-GPC or TDGPC) system is utilized. This system includes a Robotic Assistant Delivery (RAD) high temperature GPC system [other suitable high temperature GPC instruments include Waters (Milford, Mass.) model 150C High Temperature Chromatograph; Polymer Laboratories (Shropshire, UK) Model 210 and Model 220; and Polymer Char GPC-IR (Valencia, Spain)], equipped with a Precision Detectors (Amherst, Mass.) 2-angle laser light scattering (LS) detector Model 2040, an IR4 infra-red detector from Polymer ChAR (Valencia, Spain), and a 4-capillary solution viscometer (DP) (other suitable viscometers include Viscotek (Houston, Tex.) 150R 4-capillary solution viscometer (DP)). A GPC with these latter two independent detectors and at least one of the former detectors can be referred to as “3D-GPC” or “TDGPC,” while the term “GPC” alone generally refers to conventional GPC. Data collection is performed using software, e.g., Polymer Char GPC-IR. The system is also equipped with an on-line solvent degassing device, e.g., from Polymer Laboratories.

Eluent from the GPC column set flows through each detector arranged in series, in the following order: LS detector, IR4 detector, then DP detector. The systematic approach for the determination of multi-detector offsets is performed in a manner consistent with that published by Balke, Mourey, et al. (Mourey and Balke, Chromatography Polym., Chapter 12, (1992)) (Balke, Thitiratsakul, Lew, Cheung, Mourey, Chromatography Polym., Chapter 13, (1992)). Olexis LS columns is used. The sample carousel compartment is operated at 140° C. and the column compartment is operated at 150° C. The samples are prepared at a concentration of 0.1 grams of polymer in 50 milliliters of solvent. The chromatographic solvent and the sample preparation solvent is 1,2,4-trichlorobenzene (TCB) containing 200 ppmw of 2,6-di-tert-butyl-4methylphenol (BHT). The solvent is sparged with nitrogen. The polymer samples are gently stirred at 160° C. for four hours. The injection volume is 200 microliters. The flow rate through the GPC is set at 1 ml/minute.

For Conventional GPC, the IR4 detector is used, and the GPC column set is calibrated by running 21 narrow molecular weight distribution polystyrene standards. The molecular weight of the standards ranged from 580 g/mol to 8,400,000 g/mol, and the standards are contained in six “cocktail” mixtures. Each standard mixture had at least a decade of separation between individual molecular weights. The polystyrene standards are prepared at 0.025 g in 50 mL of solvent for molecular weights equal to, or greater than, 1,000,000 g/mol, and at 0.05 g in 50 mL of solvent for molecular weights less than 1,000,000 g/mol. The polystyrene standards are dissolved at 80° C., with gentle agitation, for 30 minutes. The number average molecular weight, the weight average molecular weight, and the z-average molecular weight are calculated from equations, e.g., as described in U.S. Pat. No. 8,871,887.

For the LS GPC, the Precision Detector PDI2040 detector Model 2040 is used. For 3D-GPC, absolute weight average molecular weight is calculated from equations, e.g., as described in U.S. Pat. No. 8,871,887. The gpcBR branching index is determined by calibrating the light scattering, viscosity, and concentration detector and subtracting the baselines. Integration windows are set for integration of the low molecular weight retention volume range in the light scattering and viscometer chromatograms that indicated the presence of detectable polymer from the refractive index chromatogram. Linear polyethylene standards are used to establish polyethylene and polystyrene Mark-Houwink constants. The constants are used to construct two linear references, conventional calibrations for polyethylene molecular weight and polyethylene intrinsic viscosity as a function of elution volume, e.g., as described in U.S. Pat. No. 8,871,887. To determine the gpcBR branching index, the light scattering elution area for the sample polymer is used to determine the molecular weight of the sample. Analysis is performed using the final Mark-Houwink constants, e.g., as described in U.S. Pat. No. 8,871,887.

### Accelerated Dirt Pick-Up Resistance

1. Coat aluminum panels with coating and let cure for 3 days at room temperature.
2. Mark with a water-proof marker to divide each panel into 3 sections.
3. Measure and record initial reflectance of each panel section using a BYK Gardner Spectro Guide, taking the average of three readings for each of L*a*b*.
4. Cover one section of each panel with aluminum foil. Expose the panels to UV radiation for 24 hours.
5. Prepare a dirt substitute mixture of 25 weight parts water, 0.125 weight parts OROTAN™ 731A dispersing agent, and 25 weight parts Bayferrox 130M iron oxide pigment. Mix at medium speed for 5 minutes with a dissolver mixing head.
6. Remove the aluminum foil. Apply the dirt substitute mixture to each panel on the section that was covered by aluminum foil and one section that was exposed to UV radiation. Allow to sit for 4 hours.
7. Wash each panel under running tepid water while rubbing lightly and evenly with even pressure. Air dry each panel for at least 2 hours in room temperature.
8. Measure the final (dirty) reflectance of each panel section using the BYK Gardner Spectro Guide, taking the average of three readings for each of L*a*b*. Only L is used to determine change of reflectance (ΔL).

### EXAMPLES

The following examples illustrate specific embodiments of the invention, but do not limit the broadest scope of the invention.

### Dry Mix Preparation:

The ingredients in Table 1 are obtained.

TABLE 1

| | | Chemical Description, |
|---|---|---|
| Ingredient Type | Product Name | Chemical formula, or Structure |
| White Cement | | CaO + SiO2 + Al2O3 |
| Vinyl Ester Copolymers¹ | DOW ™ Latex Polymer 2300 | Vinyl Acetate Ethylene (VEA) |
| | | Copolymer |
| | DOW ™ Latex Polymer 2000 | VAE Copolymer |
| | DOW ™ Latex Polymer 2140 | VAE-Veova Copolymer |
| | DOW ™ Latex Polymer 210 | VAE Copolymer |
| Acrylic Copolymer² | DRYCRYL ™ DP-2903 | Acrylic copolymer |
| Cellulosic Thickener | WALOCEL ™ MW 40000 PFV | Methyl Hydroxyl Ethyl Cellulose |
| Dispersant | OROTAN ™ 731 DP Dispersant | Polyacrylic Acid |
| Plasticizer | PCE Powder | Polycarboxylic Acid |
| Polysiloxane | DOWSIL ™ SHP 60 Plus | Siloxane & Silane |
| Filler | Dolomite (300 mesh) | Calcium magnesium carbonate |

¹Commercial vinyl ester copolymers may contain about 5 to 20 weight percent of an anticaking agent such as polyvinyl alcohol. Weights listed in Tables 2 and 3 reflect the weight of the commercial product, including additives.
²DRYCRYL ™ DP-2903 is a 100% acrylic copolymer redispersible powder containing from 1 to 3 weight percent calcium carbonate. DRYCRYL ™ DP 2903 acrylic redispersible powder is obtained for comparative purposes.

Dry mix samples listed in Table 2 are made using DOW™ Latex Polymer 2300 vinyl acetate ethylene copolymer by dry blending the ingredients in Table 2 for 2 minutes in a polyethylene bag. The dry-mix samples are rested for 24 hours. Samples IE1 to IE5 are examples of the invention. Sample CE1 is a comparative example that does not contain vinyl ester copolymer.

Dry mix samples listed in Table 3 are made using different vinyl ester copolymers or DRYCRYL™ DP 2903 acrylic redispersible powder by dry blending the ingredients in Table 3 for 2 minutes in a polyethylene bag. The dry-mix samples are rested for 24 hours. Samples IE6 to IE9 are examples of the invention. Sample CE2 is a comparative example that contains acrylic redispersible powder instead of vinyl ester copolymer.

### Aqueous Composition Preparation and Testing

A 500 gm sample of each dry mix is mixed with premeasured quantities of water until smooth using a stirrer at 600 rpm. When the added water provides a smooth blend with a viscosity of about 110 to 120 KU, as measured on the Brookfield viscometer in a 500 ml container, the sample is used for further testing, and the quantity of added water is listed in Table 2 or 3.

Each sample is brushed onto a concrete tile and determined to be suitable for brush application to concrete.

Samples in Table 2 are also tested for working life, water absorption, tensile adhesion and solar reflectance, as described in the Test Methods. Results are reported in Table 2. In addition, samples of CE1, IE1 and IE2 are brushed onto concrete tiles and allowed to set. The change in color (ΔE) of the tiles is measured according to ASTM D2244 from newly coated and after 10 months outdoor exposure (5° angle southwest).

Samples in Table 3 are brushed onto concrete tiles and are permitted to dry and set. The coatings are tested for impact resistance and are determined to have an impact resistance suitable for roof coatings. The coatings are also tested for water absorption, tensile adhesion and dirt pick-up resistance. The results are reported in Table 3.

TABLE 2

| | Units | CE1 | IE1 | IE2 | IE3 | IE4 | IE5 |
|---|---|---|---|---|---|---|---|
| Dry Mix Ingredients | | | | | | | |
| White Cement | Wt Parts¹ | 35 | 35 | 35 | 35 | 35 | 35 |
| DOW ™ Latex Polymer 2300 | Wt Parts | 0 | 5 | 15 | 15 | 15 | 15 |
| Cellulosic Thickener | Wt Parts | 0.4 | 0.4 | 0.4 | 0.4 | 0.4 | 0.4 |
| White Filler | Wt Parts | 64.25 | 59.25 | 49.25 | 48.25 | 48.25 | 47.25 |
| Polymeric Dispersant | Wt Parts | 0.35 | 0.35 | 0.35 | — | 0.35 | — |
| Water Reducer | Wt Parts | | | | 2 | | 2 |
| Polysiloxane | Wt Parts | | | | | 1 | 1 |
| Total | Wt Parts | 100 | 100 | 100 | 100.65 | 100 | 100.65 |
| Aqueous composition | | | | | | | |
| Water ² | Wt Parts¹ | 60 | 60 | 60 | 40 | 60 | 40 |
| Measured Properties | | | | | | | |
| Viscosity | Krebs | 111.3 | 112.4 | 111.3 | 109.3 | 106.9 | 105.3 |
| | Units | | | | | | |
| Working life | minutes | 240 | 240 | 240 | 240 | 240 | 240 |
| Water Absorption, 7 days | % | 21.83 | 27.05 | 31.96 | 27.66 | 22.60 | 21.44 |
| Tensile Adhesion, 14 days | MPa | 1.04 | 1.19 | 1.49 | — | — | — |
| Solar Reflectance Index | % | 125.00 | 108.00 | 117 | — | — | — |
| Color Change (ΔE), 10 | % | 22.75 | 14.23 | 6.93 | | | |
| Months Exposure | | | | | | | |

¹Weight Parts based on weight of dry mix ingredients, excluding water.
² Quantity of water is selected to provide a slurry having viscosity from about 110-120 KU.
3 - Color Change (ΔE) measures change in color of a sample after time (10 months, 5° angle southwest) exposed to ambient airborne dirt and dust. Lower numbers are better, and 0.00 indicates no measurable color change.

TABLE 3

| | | IE6 | IE7 | IE8 | IE9 | CE2 |
|---|---|---|---|---|---|---|
| Dry Mix Ingredients | | | | | | |
| White Cement | Wt Parts¹ | 35 | 35 | 35 | 35 | 35 |
| Cellulosic Thickener | Wt Parts | 0.4 | 0.4 | 0.4 | 0.4 | 0.4 |
| Dispersant | Wt Parts | 0.35 | 0.35 | 0.35 | 0.35 | 0.35 |
| White Filler | Wt Parts | 49.25 | 49.25 | 49.25 | 49.25 | 49.25 |
| Redispersible Powder | | | | | | |
| DOW ™ Latex Polymer 2300 | Wt Parts | 15 | | | | |
| DOW ™ Latex Polymer 2000 | Wt Parts | | 15 | | | |
| DOW ™ Latex Polymer 2140 | Wt Parts | | | 15 | | |
| DOW ™ Latex Polymer 210 | Wt Parts | | | | 15 | |
| DRYCRYL ™ DP 2903 | | | | | | 15 |
| Total | Wt Parts | 100 | 100 | 100 | 100 | 100 |
| Aqueous Composition | | | | | | |
| Water² | Wt Parts¹ | 60 | 62 | 68 | 70 | 70 |
| Measured Properties | | | | | | |
| Viscosity | Krebs | 112 | 109.4 | 118 | 110.7 | 111.3 |
| | Units | | | | | |
| Water Absorption, 7 Days | % | 32.89 | 26.26 | 27.76 | 29.73 | 32.79 |
| Tensile Adhesion, 14 Days | MPa | 1.19 | 1.23 | 1.17 | 1.21 | 1.16 |
| Accelerated Dirt Pick-Up | % | 6.78 | 7.88 | 7.88 | 1.51 | 31.49 |
| Resistance⁴, Δ L | | | | | | |

¹Weight Parts based on weight of dry mix ingredients, excluding water.
²Quantity of water is selected to provide a slurry having viscosity from about 110-120 KU.
3 - Accelerated Dirt Pickup Resistance measures change in reflectance (L) of a sample after (1) exposure to UV and/or dirt substitute mixture, and (2) light washing, as described in the Test Methods. Lower numbers are better. Results on this Table are for the panel sections that are exposed to both UV and dirt substitute.

1. A dry mix composition comprising:
a. From 20 to 40 weight percent of white cement;
b. From 5 to 30 weight percent of a vinyl ester copolymer which has a glass-transition temperature of −20° C. to 35° C.;
c. at least 0.1 weight percent of a cellulosic thickener; and
d. at least 30 weight percent white fillers in which 95 to 100 parts-per-hundred, by weight, of the particles of white filler have a particle size of no more than 75 microns,
wherein the dry mix composition contains no more than 0.1 weight percent silica and no more than 5 weight percent pozzolans, and all weight percentages are based on the combined weight of the dry components (a)-(d).

2. The dry mix composition of claim 1 wherein the vinyl ester copolymer is in the form of a redispersible powder that further comprises an emulsifier.

3. The dry mix composition of claim 2 wherein the vinyl ester copolymer comprises one or more of a vinyl acetate-ethylene copolymer or a vinyl ester of versatic acid copolymer, and the emulsifier comprises poly-vinyl alcohol.

4. The dry mix composition of claim 1 which further comprises (e) a polymeric dispersant.

5. The dry mix composition of claim 4 which further comprises (f) a silicon-containing polymer.

6. The dry mix composition of claim 5 wherein the content of components (a)-(f) is:
a. From 20 to 40 weight percent of white cement;
b. From 10 to 20 weight percent of a vinyl ester copolymer which has a glass-transition temperature of from −20° C. to 25° C.;
c. from 0.1 to 1 weight percent of a cellulosic thickener, and
d. at least 30 weight percent white fillers in which 95 to 100 parts-per-hundred, by weight, of the particles of white filler have a particle size of no more than 55 micron,
e. from 0.2 to 2 weight percent polymeric dispersant, and
f. up to 3 weight percent silicon-containing polymer,
wherein all weight percentages are based on the weight of the dry components (a)-(f).

7. An aqueous composition comprising the dry mix components of claim 1 and further comprising water in a quantity such that the aqueous composition is a slurry that has a viscosity of 85 KU to 130 KU.

8. The aqueous composition of claim 7 which has a viscosity from 100 to 120 KU.

9. The aqueous composition of claim 7 which provides a set coating that has a solar reflectance index of at least 90.

10. The aqueous composition of claim 9 which provides a set coating that experiences a color change (ΔE) of no more than 15 percent, when measured according to ASTM D2244, after 10 months exposure outdoors.
